(19) United States
(12) Patent Application Publication
(10) Pub. No.: US 2011/0120955 A1
(43) Pub. Date: May 26, 2011

(54) METHODS FOR REMOVING FATS, OIL AND GREASE AND RECOVERING TALLOW FROM WASTEWATER

(76) Inventor: Michael R. Wood, Philadelphia, PA (US)

(21) Appl. No.: 13/055,986

(22) PCT Filed: Jul. 31, 2008
(86) PCT No.: PCT/US08/71711

§ 371 Date: Jan. 26, 2011

(51) Int. Cl. B01D 17/05; C02F 1/56; B01D 17/00; B01D 21/01

(52) U.S. Cl. 210/705; 210/708

(57) ABSTRACT

A method for recovering tallow from food or animal processing wastewater includes adding a flocculant to the wastewater to agglomerate suspended fats, oil and grease particles in the wastewater, separating solid waste materials from the wastewater and processing the solid waste materials to recover tallow. The flocculant includes polyacrylamide or an acrylamide copolymer. A process for separating fats, oil and grease from food or animal processing wastewater is also provided.

### FIELD OF THE INVENTION

This invention relates generally to recovering tallow and more particularly, to removing fats, oil and grease and recovering tallow from food or animal processing wastewater.

### BACKGROUND

Tallow is an important raw material in animal feed and as a feedstock for production of biofuels, such as biodiesel, oleo-chemicals and pharmaceuticals, which can be obtained by rendering animal or plant-based fats, oil and grease. Wastewater from food or animal processing plants contains animal fats, oil and grease, which must be removed to clarify the wastewater.

Conventional treatment for clarifying wastewater includes using a clarifier or flotation unit, such as a dissolved air flotation or entrapped air flotation unit, to separate suspended solid particles, including fats, oil and grease, into a solid phase that floats up or sinks down in the treatment units. The solid phase may be used as is or may be further processed to separate the tallow, as in a tricanter centrifuge or cooking process.

Demulsifying coagulants and flocculants are often used to aid in separating the solid phase from the wastewater, because fats, oil and grease can form emulsions with the wastewater that are difficult to separate. The traditionally used demulsifying treatments can contain inorganic materials, such as metal salts of aluminum or iron, which are used at high dosage levels to affect the desired separation. These treatments can be harmful to the environment and leave residual metals and products in the fats, oil and grease. These treatment additives can become a source of contaminants in the tallow and biodiesel production, which is detrimental to biodiesel reactors, diesel engines and the overall tallow quality. Also, traditionally used demulsifying treatments often require pH adjustment of the wastewater to obtain an alkalinity or acidity suitable for the treatment.

What is needed is an improved and environmentally friendly process for removing fats, oil and grease from food or animal processing wastewater and recovering tallow, while maintaining the desired tallow quality characteristics.

### BRIEF DESCRIPTION

In one embodiment, a method for recovering tallow from food or animal processing wastewater includes adding a flocculant to the wastewater to agglomerate suspended fats, oil and grease particles in the wastewater, separating solid waste materials from the wastewater and processing the solid waste materials to recover tallow, wherein said flocculant includes polyacrylamide or an acrylamide copolymer.

In another embodiment, a method for recovering fats, oil and grease in a solid phase from food or animal processing wastewater includes adding from about 1 part per million by volume to about 30 parts per million by volume of a flocculant to the wastewater to agglomerate suspended fats, oil and grease particles in the wastewater and separating solid waste materials from the wastewater, wherein said flocculant includes polyacrylamide or an acrylamide copolymer.

The various embodiments provide enhanced removal of fats, oil and grease and recovery of tallow from food and animal processing wastewaters with treatments and levels that are GRAS (generally recognized as safe) for animal feed without the addition of contaminating inorganic materials and without the need for pH adjustments of the wastewater to be treated.

### DETAILED DESCRIPTION OF THE INVENTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

In one embodiment, a method for recovering tallow from food or animal processing wastewater includes adding a flocculant to the wastewater to agglomerate suspended fats, oil and grease particles in the wastewater, separating solid waste materials from the wastewater and processing the solid waste materials to recover tallow, wherein said flocculant includes polyacrylamide or an acrylamide copolymer.

Food or animal processing wastewater is any type of wastewater discharged from food processing industries or animal processing industries, such as slaughterhouse wastewater and wastewater from restaurants and other food industries. Food or animal processing wastewater includes fats, oil and grease from animals, such as cattle, hogs, sheep and poultry. The wastewater may also contain settleable and unsettleable solids and proteinaceous substances.

A flocculant is added to the food or animal processing wastewater to agglomerate suspended fats, oil and grease particles. The flocculant increases the amounts of fats, oil and grease particles separated from the wastewater by selectively agglomerating fats, oil and grease particles from other solids present in the wastewater.

The flocculant includes polyacrylamide or an acrylamide copolymer. In one embodiment, the polyacrylamide is a homopolymer. In another embodiment, the flocculant may be a cationic acrylamide copolymer, an anionic acrylamide copolymer or a nonionic acrylamide copolymer. The polyacrylamide includes, but is not limited to, polyacrylamide, polymethacrylamide, poly-N-methylolacrylamide, poly-N,N-dimethylacrylamide, dialkylaminoalkyl(meth)acrylamide polymer, dimethylaminopropyl methacrylamide polymer or dimethylaminopropyl acrylamide polymer. The alkyl groups may be methyl, ethyl, propyl, isopropyl, butyl, isobutyl, pentyl or hexyl.

Acrylamide copolymers include, but are not limited to, acrylamide/dimethylaminoethyl (meth)acrylate methyl chloride quaternary copolymer, acrylamide/acrylic acid copolymer, acrylamide/2-acrylamido-2-methylpropanesulfonic acid copolymer, 2-acryloxyethyltrimethylammonium chloride/acrylamide copolymer, an acrylic acid copolymer containing acrylamidopropyltrimethyl ammonium chloride, methacrylamidopropyltrimethyl ammonium chloride, acrylamidopropyl sulfonate, acrylamide, or mixtures thereof or an acrylamide copolymer containing dimethylaminoethyl methacrylate, acrylamidopropyltrimethyl ammonium chloride, methacrylamidopropyltrimethyl ammonium chloride, acrylamidopropyl sulfonate or mixtures thereof.

The mole ratio of the comonomer to the acrylamide monomer in the acrylamide copolymer may be in any amount. In one embodiment, the mole ratio of the comonomer to the acrylamide in the acrylamide copolymer can range from about 1:99 to about 99:1. In another embodiment, the mole ratio of the comonomer to the acrylamide is from about 20:80 to about 99:1. In another embodiment, the ratio is from about 40:60 to about 80:20.

The molecular weight of the polyacrylamide or the acrylamide copolymer is not critical, but must be water soluble or dispersible. In one embodiment, the number average molecular weight is from about 500 to about 2,000,000. In another embodiment, the number average molecular weight is from about 5000 to about 200,000.

The polyacrylates and acrylamide copolymers are available commercially or may be made in a conventional manner, such as disclosed in U.S. Pat. No. 5,730,905, which is incorporated herein by reference.

The flocculant is added to the wastewater in any conventional manner and the flocculant readily disperses within the wastewater. In one embodiment, the flocculant is injected to the wastewater. The flocculant may be added to the wastewater neat or in an aqueous solution either continuously or intermittently. In another embodiment, the flocculant is added to the wastewater in conventional wastewater treatment units, such as a clarifier, an entrapped air flotation system or a dissolved air flotation system.

The flocculant works in a wide range of pH values and adjusting the pH of the wastewater is not necessary. In one embodiment, the flocculant is added to the wastewater without adjusting the pH value of the wastewater.

The flocculant may be added in any amount effective for agglomerating suspended fats, oil and grease in wastewater and that is at GRAS levels for environmentally acceptable levels for animal feed. The actual dosage depends upon the characteristics of the wastewater to be treated. In one embodiment, the flocculant is added to the wastewater in an amount of from about 1 part per million by volume to about 30 parts per million by volume. In another embodiment, the flocculant is added to the wastewater in an amount of from about 5 parts per million by volume to about 25 parts per million by volume. In another embodiment, the flocculant is added to the wastewater in an amount of from about 10 parts per million by volume to about 20 parts per million by volume.

Solid waste materials in the wastewater are separated from the wastewater in a solid phase and removed. The solid phase may be separated in any conventional manner. In one embodiment, the solid phase is separated from the wastewater by settling. Conventional treatment units, such as clarifiers or flotation units, such as a dissolved air flotation or entrapped air flotation units, can be used to separate the solid phase from the wastewater.

Solid particles containing fats, oil and grease settle into the solid phase and are removed from the wastewater with the solid phase. Agglomerated particles of fats, oil and grease also settle into the solid phase and are removed from the wastewater with the solid phase.

The solid waste materials removed from the wastewater may be processed to recover tallow. The term “tallow” is used generally to include rendered fats, oil and grease from animals, such as sheep, lamb, poultry, beef and pork and includes the term “lard”, which specifically refers to rendered pork fats, oil and grease.

In one embodiment, the solid waste materials are heated to liquefy the tallow component. In one embodiment, the solid waste materials are heated to a temperature in the range of from about 70° C. to about 95° C. In another embodiment, the solid waste materials are heated with steam to a temperature in the range of from about 70° C. to about 95° C. In another embodiment, the solid waste materials are heated in a cooker.

In another embodiment, the tallow is isolated from the solid waste materials. In one embodiment, the heated solid waste materials are separated in a centrifuge into three phases: stick water, tallow and solids. The centrifuge may be any type of conventional centrifuge or tricanter.

In another embodiment, a method for recovering fats, oil and grease in a solid phase from food or animal processing wastewater includes adding from about 1 part per million by volume to about 30 parts per million by volume of a flocculant to the wastewater to agglomerate suspended fats, oil and grease particles in the wastewater and separating solid waste materials from the wastewater, wherein said flocculant includes polyacrylamide or an acrylamide copolymer. The polyacrylamides and acrylamide copolymers are described above.

In order that those skilled in the art will be better able to practice the present disclosure, the following examples are given by way of illustration and not by way of limitation.

### EXAMPLES

### Example 1

Suspended Fats, Oil and Grease (FOG) testing was performed to measure the removal of FOG from wastewater from a beef slaughterhouse facility. The FOG testing was performed in accordance with Hexane Extractable HEM Oil & Grease Test EPA Method 1664 HEM.

A flocculant, 60/40 2-acryloxyethyltrimethyl ammonium chloride/acrylamide copolymer (available commercially as FoodPro SA9692 from GE Water & Process Technologies), was added to the wastewater that was flowing through a dissolved air flotation (DAF) unit. Table 1 shows the results for Example 1 and for CE-1, an untreated wastewater sample.

TABLE 1

| | CE-1 | Example 1 |
|---|---|---|
| Flocculant Dosage (ppm) | 0 | 15 |
| DAF Influent FOG (ppm) | 6705 | 7517 |
| DAF Effluent FOG (ppm) | 1099 | 887 |
| FOG Removed (ppm) | 5606 | 6630 |
| % FOG Removed | 83.6% | 88.2% |
| Flow (Million Gallons/day) | 1.76 | 1.90 |

Example 1 shows an increased removal of FOG from the wastewater. The treatment dosages are at GRAS levels and result in very clean effluent from the DAF.

### Example 2

The solid phase that floated up during the CE-1 sample and Example 1 sample was centrifuged in a full-scale tricanter centrifuge. The solid phase was warm from the DAF unit and was not further heated.

The centrifuging process separated the solid phase into three distinct layers, tallow, water and solids. The tallow quality was measured for three parameters: moisture, free fatty acids and unsapponifiable matter. The tests were performed in accordance with the American Oil Chemist Society's tests methods: Moisture—Method AOCS Ca 3B-38, Free Fatty Acids—ASTM D 1980 Standard Test Method for Acid Value of Fatty Acids and Polymerized Fatty Acids and Unsaponifiable Matter—Method AOCS Ca 6A-40. The data is shown in Table 2.

TABLE 2

| | | Moisture | |
|---|---|---|---|
| Sample | Unsapponifiables % | (ppm) | Free Fatty Acid (ppm) |
| CE-1 | 0.41 | 29 | 15 |
| Ex. 1 | 0.39 | 13 | 10 |

Table 2 shows that the quality of tallow from Example 1 is improved over the quality of tallow from CE-1 (Lower numbers for Unsapponifiables, Moisture and Free Fatty Acids indicate improved quality).

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

What is claimed is:

1. A method for recovering tallow from food or animal processing wastewater comprising adding a flocculant to the wastewater to agglomerate suspended fats, oil and grease particles in the wastewater, separating solid waste materials from the wastewater and processing the solid waste materials to recover tallow, wherein said flocculant comprises polyacrylamide or an acrylamide copolymer.

2. The method of claim 1 wherein the flocculant is a cationic acrylamide copolymer, an anionic acrylamide copolymer or a nonionic acrylamide copolymer.

3. The method of claim 1 wherein the polyacrylamide or acrylamide copolymer is selected from the group consisting of polyacrylamide, polymethacrylamide, poly-N-methylolacrylamide, poly-N,N-dimethylacrylamide, dialkylaminoalkyl(meth)acrylamide polymer, dimethylaminopropyl methacrylamide polymer and dimethylaminopropyl acrylamide polymer, acrylamide/dimethylaminoethyl (meth)acrylate methyl chloride quaternary copolymer, acrylamide/acrylic acid copolymer, acrylamide/2-acrylamido-2-methylpropanesulfonic acid copolymer and 2-acryloxyethyltrimethylammonium chloride/acrylamide copolymer.

4. The method of claim 1 wherein the acrylamide copolymer is an acrylic acid copolymer containing acrylamidopropyltrimethyl ammonium chloride, methacrylamidopropyltrimethyl ammonium chloride, acrylamidopropyl sulfonate, acrylamide, or mixtures thereof.

5. The method of claim 1 wherein the acrylamide copolymer is an acrylamide copolymer containing dimethylaminoethyl methacrylate, acrylamidopropyltrimethyl ammonium chloride, methacrylamidopropyltrimethyl ammonium chloride, acrylamidopropyl sulfonate, or mixtures thereof.

6. The method of claim 2 wherein the mole ratio of a comonomer to the acrylamide in the acrylamide copolymer is from about 1:99 to about 99:1.

7. The method of claim 1 wherein the polyacrylamide or acrylamide copolymer has a number average molecular weight from about 500 to about 2,000,000.

8. The method of claim 1 wherein the flocculant is injected to the wastewater.

9. The method of claim 1 wherein the flocculant is added to the wastewater in a clarifier, an entrapped air flotation system or a dissolved air flotation system.

10. The method of claim 1 wherein the flocculant is added to the wastewater without adjusting the pH value of the wastewater.

11. The method of claim 1 wherein the flocculant is added to the wastewater in an amount of from about 1 part per million by volume to about 30 parts per million by volume.

12. The method of claim 1 wherein the solid waste materials are separated from the wastewater by settling.

13. The method of claim 1 wherein the solid waste materials are separated from the wastewater in a clarifier or flotation unit.

14. The method of claim 12 wherein the flotation unit is a dissolved air flotation unit or an entrapped air flotation unit.

15. The method of claim 1 wherein the solid waste materials are processed by heating.

16. The method of claim 15 wherein the solid waste materials are heated to a temperature in the range of from about 70° C. to about 95° C.

17. The method of claim 1 wherein tallow is isolated from the solid waste materials.

18. The method of claim 17 wherein the solid waste materials are separated in a centrifuge into at least two phases including a tallow phase and the tallow phase is removed.

19. A method for recovering fats, oil and grease in a solid phase from food or animal processing wastewater comprising adding from about 1 part per million by volume to about 30 parts per million by volume of a flocculant to the wastewater to agglomerate suspended fats, oil and grease particles in the wastewater and separating solid waste materials from the wastewater, wherein said flocculant comprises polyacrylamide or an acrylamide copolymer.

20. The method of claim 19 wherein the flocculant is a cationic acrylamide copolymer, an anionic acrylamide copolymer or a nonionic acrylamide copolymer.

21. The method of claim 19 wherein the polyacrylamide or acrylamide copolymer is selected from the group consisting of polyacrylamide, polymethacrylamide, poly-N-methylolacrylamide, poly-N,N-dimethylacrylamide, dialkylaminoalkyl(meth)acrylamide polymer, dimethylaminopropyl methacrylamide polymer, dimethylaminopropyl acrylamide polymer, acrylamide/dimethylaminoethyl (meth)acrylate methyl chloride quaternary copolymer, acrylamide/acrylic acid copolymer, acrylamide/2-acrylamido-2-methylpropanesulfonic acid copolymer and 2-acryloxyethyltrimethylammonium chloride/acrylamide copolymer.

22. The method of claim 19 wherein the acrylamide copolymer is an acrylic acid copolymer containing acrylamidopropyltrimethyl ammonium chloride, methacrylamidopropyltrimethyl ammonium chloride, acrylamidopropyl sulfonate, acrylamide, or mixtures thereof.

23. The method of claim 19 wherein the acrylamide copolymer is an acrylamide copolymer containing dimethylaminoethyl methacrylate, acrylamidopropyltrimethyl ammonium chloride, methacrylamidopropyltrimethyl ammonium chloride, acrylamidopropyl sulfonate, or mixtures thereof.

24. The method of claim 19 wherein the polyacrylamide or acrylamide copolymer has a number average molecular weight from about 500 to about 2,000,000.

25. The method of claim 19 wherein the flocculant is injected to the wastewater.

26. The method of claim 19 wherein the flocculant is added to the wastewater in a clarifier, an entrapped air flotation system or a dissolved air flotation system.

27. The method of claim 19 wherein the flocculant is added to the wastewater without adjusting the pH value of the wastewater.

28. The method of claim 19 wherein the solid waste materials are separated from the wastewater by settling.

29. The method of claim 19 wherein the solid waste materials are separated from the wastewater in a clarifier or flotation unit.

30. The method of claim 19 wherein the flotation unit is a dissolved air flotation unit or an entrapped air flotation unit.
